(19) United States
(12) Patent Application Publication
(10) Pub. No.: US 2015/0095051 A1
(43) Pub. Date: Apr. 2, 2015

(54) AUTOMATED ALGORITHM AND FRAMEWORK FOR MULTI-PATIENT TREATMENT PLAN ACCESS IN RADIATION THERAPY

(71) Applicant: KONINKLIJKE PHILIPS N.V., EINDHOVEN (NL)

(72) Inventors: Shyam Bharat, Ossining, NY (US); Matthieu Frederic Bal, Cadier en Keer (NL); Parag Jitendra Parikh, St. Louis, MO (US); Kevin Lawrence Moore, Clayton, MO (US)

(21) Appl. No.: 14/360,318

(22) PCT Filed: Nov. 30, 2012
(86) PCT No.: PCT/IB2012/056851

§ 371 Date: May 23, 2014

Related U.S. Application Data
(60) Provisional application No. 61/564,882, filed on Nov. 30, 2011.

(51) Int. Cl. G06F 19/00; G06Q 50/22

(52) U.S. Cl. CPC G06F 19/3487; G06F 19/322; G06Q 50/22
USPC 705/2

(57) ABSTRACT

A method for reviewing a treatment plan including displaying list of at least one of a selected plurality of patients, institutions, and treatment plans associated with a treatment planning system, selecting at least one of the one or more patients, institutions, and treatment plans, querying treatment plan parameters associated with the selected one or more patients, institutions, and treatment plans, and generating a report file of the queried treatment plan parameters

The present application relates generally to radiation therapy. It finds particular application in conjunction with an automated review procedure for accessing radiation therapy treatment plan data from multiple patient plans. However, it is to be understood that it also finds application in other treatment plan review scenarios and is not necessarily limited to the aforementioned application.

In radiation therapy, spatially targeted doses of radiation are applied to targets, such as tumors, containing cancerous or malignant tissue, of a patient. Growing and rapidly multiplying cancer cells tend to be more susceptible to damage from radiation, as compared with normal cells, such that dosages administered by proper planning preferentially kill cancerous or malignant tissue. Current external beam radiation therapy (EBRT) involves a detailed treatment planning process that follows an initial imaging protocol. The planning typically involves the use of a single 3D/4D CT image set to develop a detailed treatment plan, including contours around targets and organs at risk (OARs), radiation beam directions, energies, dose constraints, and the like. The treatment is delivered in daily fractions based on this treatment plan. Typically, after the treatment is delivered, a retrospective review of different parameters in a treatment plan is performed.

The retrospective review is used to relate the treatment plan parameters to delivery outcomes, compare a particular set of treatment plans to a pre-defined institutional or practice standard to ensure plan quality, inter-physician plan performance studies, and the like. For example, retrospective review of treatment plans may be used to assess the risks posed to normal tissues by the 3D dose distributions used in Intensity Modulated Radiation Therapy (IMRT) and 3D Conformal Radiation Therapy (3D CRT) according to Quantitative Analysis of Normal Tissue Effects in the Clinic (QUANTEC) guidelines. Moreover, the American Board of Radiology (ABR) requires all ABR-certified physicians to perform two retrospective treatment plan reviews every ten years in order to maintain ABR certification. Additionally, other agencies like Centers for Medicare and Medicaid Services (CMS) link physician data reporting initiatives to reimbursement incentives. Individual hospitals may also have their own quality assurance programs, which require physicians to report data from treatment plans in a retrospective manner, as a measure of periodic validation of physician quality. Thus, the need for generating review reports from large sets of treatment plans is widespread.

However, manually extracting plan data from a treatment-planning system (TPS) can be tedious and time-consuming since patient cohorts typically can include hundreds of patient plans. Also, the amount of data being generated can cumulatively become rather unwieldy. An automated framework for extracting plan data from a TPS and performing retrospective plan reviews on multiple patients without having to manually open each patient's treatment plan can potentially be a very valuable tool. The resulting time saved and the streamlined manner of data handling in an automated protocol will be hugely beneficial for large institutions and clinics, which will need to perform such plan reviews on a routine basis.

The present application provides a new and improved system and method which provide such a framework and overcomes the above-referenced problems and others.

In accordance with one aspect, a method for reviewing a treatment plan is provided. The method including displaying list of at least one of a selected plurality of patients, institutions, and treatment plans associated with a treatment planning system, selecting at least one of the one or more patients, institutions, and treatment plans, querying treatment plan parameters associated with the selected one or more patients, institutions, and treatment plans, and generating a report file of the queried treatment plan parameters.

In accordance with another aspect, a treatment planning system is provided. The system including a display which displays at least one of all patients, institutions, and treatment plans associated with a treatment planning system, a planning system which enables a clinician to select at least one of the one or more patients, institutions, and treatment plans, and a treatment report system queries treatment plan parameters associated with the selected one or more patients, institutions, and treatment plans and generates a report file of the queried treatment plan parameters.

In accordance with another aspect, a treatment planning system is provided. The system including one or more processors programmed to display at least one of all patients, institutions, and treatment plans associated with a treatment planning system, select at least one of the one or more patients, institutions, and treatment plans, query treatment plan parameters associated with the selected one or more patients, institutions, and treatment plans, and generate a report file of the queried treatment plan parameters.

One advantage resides in the automated review of treatment plan data.

Another advantage resides in the time and cost savings associated with automated treatment plan review.

Another advantage resides in the customized review of treatment plans.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

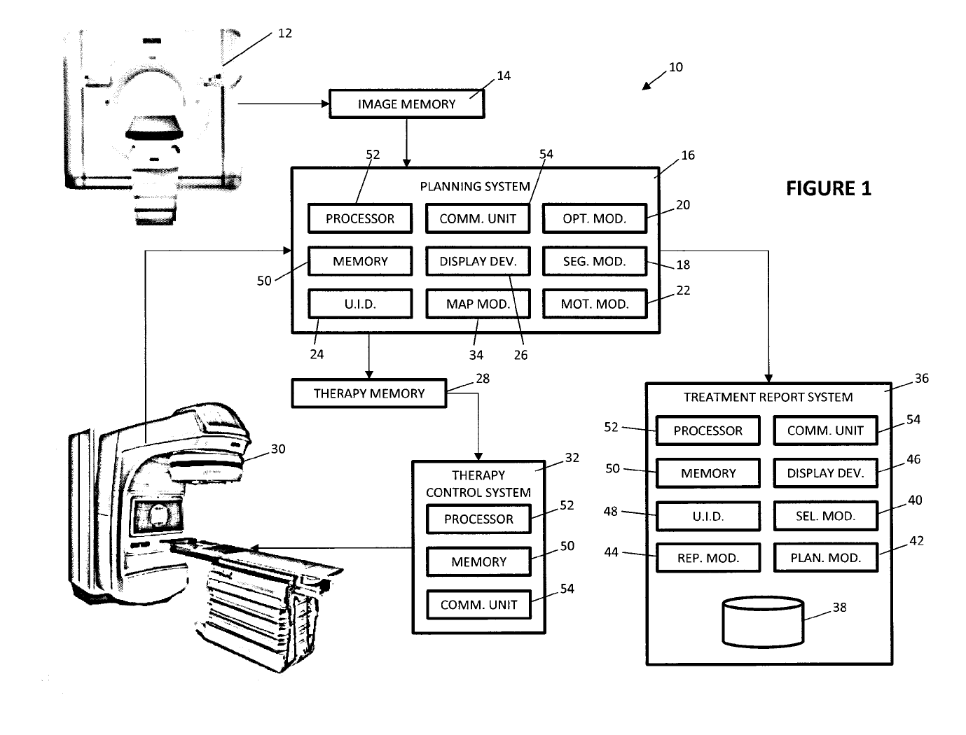

FIG. 1 is a radiation therapy system in accordance with the present application.

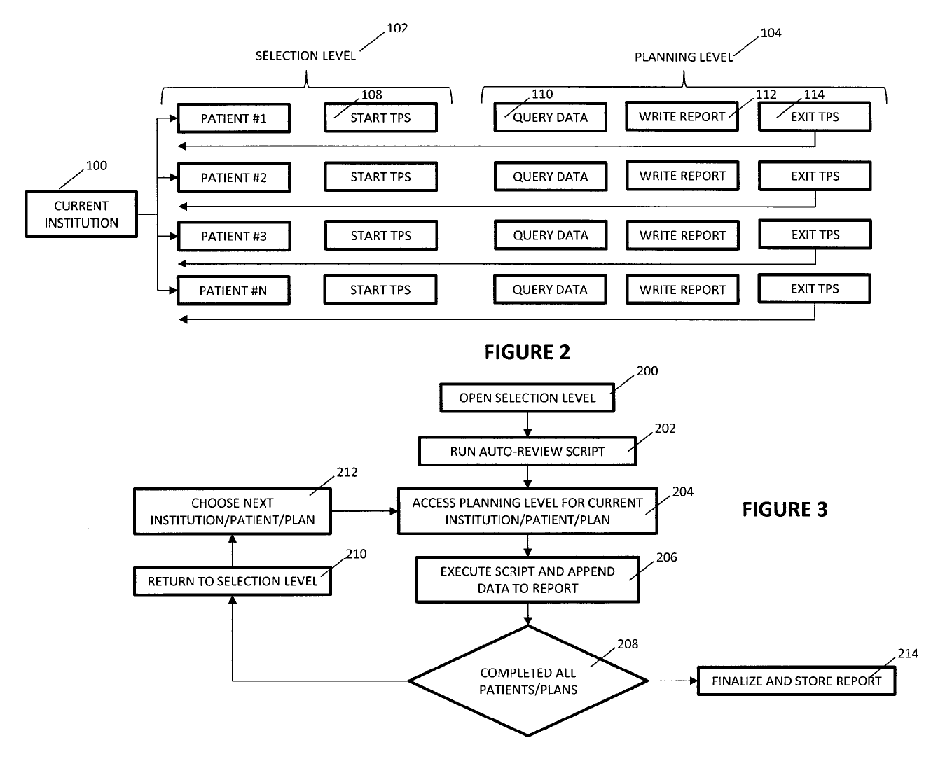

FIG. 2 is a flowchart diagram for automated multi-patient treatment plan access in accordance with the present application.

FIG. 3 is another flowchart diagram for automated multi-patient treatment plan access in accordance with the present application.

With reference to FIG. 1, a therapy system 10 includes one or more imaging modalities 12 for acquiring images of targets and/or organs at risk (OAR) within patients. The imaging modalities 12 suitably include one or more of a computed tomography (CT) scanner, a positron emission tomography (PET) scanner, a magnetic resonance (MR) scanner, a single photon emission computed tomography (SPECT) scanner, a cone-beam computed tomography (CBCT) scanner, and the like. Images acquired from the imaging modalities 12 are stored in one or more image memories 14.

A planning system 16 of the therapy system 10 receives images, such as three- and/or four-dimensional image sets, of targets and/or organs at risk for patients. Typically, the images are received from the imaging modalities 12 via the image memories 14, but other sources are contemplated. Using these images, the planning system 16 generates and/or updates treatment plans for the patients. The treatment plans includes treatment plan parameters such as contours around targets and organs at risk (OARs), global beam intensity or weight, beam direction, wedge angle, fractionation schedule, energies, dose constraints, the target organ or region, and the like. To facilitate therapy planning, the planning system 16 includes one or more of a segmentation module 18, an optimization module 20, and a motion module 22. The segmentation module 18 identifies and delineates between regions, such as targets and organs at risk, in the received images. Such regions are typically delineated by contours surrounding the regions. Identification and delineation can be performed manually, semi-automatically, and/or automatically. As to the former, the segmentation module 18 cooperates with the user interface device 24 to allow clinicians to manually identify and delineate between the regions or adjust machine segmentation.

The user interface device 24 allows clinicians to at least one of generate, modify, and view contours. In that regard, the planning system 16 displays images and, in some embodiments, corresponding contours on a display device 26. Clinicians can then generate and/or modify contours on the images using one or more user interface devices 24. For example, a clinician can employ a mouse and various pulling or pushing tools to resize or reshape a contour. Additionally or alternatively, the user interface device 24 allows clinicians to enter and/or define plan parameters, such as dose for contoured regions.

The optimization module 20 receives as input at least contours and treatment plan parameters, typically generated by the segmentation module 18 and/or the user interface device 24. The optimization module 20 optionally receives other relevant inputs, such as an attenuation map indicative of radiation absorption and/or cumulative motion patterns for targets and/or organs at risk. Based on the inputs, the optimization module 20 generates a treatment plan complying with the treatment plan parameters and any other relevant inputs. The treatment plan suitably includes a plurality of fractions and a planned treatment volume (PTV) to be irradiated. Treatment plans generated by the optimization module 20 are suitably stored in one or more therapy memories 28.

The motion module 22, in some embodiments, further works in conjunction with the other modules to facilitate the generation of a motion compensated treatment plan. For each sample of collected motion data (i.e., for each determination of shape), rigid motion is estimated. Rigid motion includes, for example, translations and rotations. In some embodiments, non-rigid motion is additionally or alternatively employed. The motion estimates are applied to the locations of each target or organ at risk in the planning image to yield motion compensated locations. A cumulative motion pattern, such as a probability density functions, for each target and/or organ at risk is determined by accumulating the motion-compensated locations therefor. The more samples collected, the more accurate the cumulative motion patterns.

Once the cumulative motion patterns are generated, they are provided to the optimization module 20 to generate a treatment plan. For example, the optimization module 20 employs the cumulative motion patterns to plan motion compensated dose distributions for each treatment fraction. Motion compensated dose distributions can be generated by convolving planned dose distribution with the corresponding cumulative motion patterns. For example, the dose distribution for a subset of fractions is convolved with the cumulative motion patterns corresponding to that subset of fractions, from the target to be irradiated.

The motion compensated dose distributions are then accumulated to get the motion compensated estimate of the dose delivered to the patient. It is contemplated that the motion compensated estimate can be determined during the execution of a treatment plan or after the execution of a treatment plan. Further, the motion compensated estimate of the dose delivered to the patient can be employed to facilitate the updating of treatment plans. For example, the motion compensated estimate can be passed to the optimization module 20 for re-optimization of the treatment plan. It is contemplated that updating can be performed in real time during the execution of a treatment fraction, after a treatment fraction, or at any other point during the execution of a treatment plan.

At a scheduled day and time for a therapy session of a patient, a therapy delivery apparatus 30 delivers therapy to the patient. The therapy, such as ablation therapy and/or brachytherapy, can include radiation involving one or more of x-rays, protons, high-intensity focused ultrasound (HIFU), and the like. Suitably, the therapy delivery apparatus 30 is controlled by a therapy control system 32 in accordance with the therapy treatment plan or the updated treatment plan. The therapy treatment plan can be received from, for example, the therapy memories 28.

The therapy beam is focused on the planned location of the target and/or the OARs. The beam intensity and the treatment location are supplied to a mapping module 34 of the planning system 16 to calculate a delivery dose map depicting the radiation dose actually delivered to the target and/or OARs during the session. Delivery dose maps generated by the mapping module 34 are suitably stored in one or more therapy memories 28. The delivery dose maps also include treatment plan parameters including the delivered dose, the delivered beam intensity and weight, the delivered beam direction, and the like. By comparing the actually delivered dose to the planned doses, the planning system 16 calculates adjustment to the treatment plan for the subsequent fractions or the remaining portion of the same fraction.

To access and review the treatment plans and/or the delivery dose maps, the therapy system 10 includes a treatment report system 36. The automated access and review of treatment plans and/or delivery dose maps includes a selection level and a planning level. First, at the selection level, a list of all the medical institutions, patients, treatment plans, dose delivery maps, clinicians, and the like associated with the treatment report system 36 are displayed. A list of all the patients' treatment plans and/or delivery dose maps to be queried is dynamically created from a clinician's desired selection from the list of all the medical institutions, patients, treatment plans, dose delivery maps, clinicians, and the like. The process steps through each of the treatment plans and/or delivery dose maps for each patient, each clinician, or each institution sequentially. At the planning level, a treatment plan and/or delivery dose map of one patient is opened or the treatment plans and/or delivery dose maps specific to two or more patients are opened for comparison. Key treatment plan parameters, such as dose per organ, both for target and at-risk tissue, and other key factors for the treatment plan and/or delivery dose map are evaluated and written to a report. After the evaluation of the patient treatment, the treatment report system 36 returns to the selection level and the process is repeated for the next patient of the clinician or institution to be evaluated. It is also contemplated that the treatment report system 36 can evaluate multiple patients and associated treatment plans and/or delivery dose maps in a parallel manner.

The treatment plans and/or delivery dose maps are supplied from the therapy memory 28 and the planning system 16 to the treatment report system 36 for automated treatment plan review. The supplied treatment plans are stored as treatment plan data in a treatment database 38 within the treatment report system 36. Likewise, the supplied delivery dose maps are stored as treatment delivery data in the treatment database 38 within the treatment report system 36. To facilitate access and review of the treatment plan data and/or treatment delivery data, the treatment report system 36 includes one or more of a selection module 40, a planning module 42, and a reporting module 44.

The selection module 38 displays the medical institutions, patients, the treatment plans, dose delivery maps, clinicians, and the like associated with the treatment report system 36 on a display device 46. For example, the selection module 40 displays a list of all the institutions that are present in the treatment database 38 and a list of the associated patients in each of the institutions. The selection module 40 also displays a list of all of the clinicians that are present in the database and a list of their associated patients. The selection module 38 also displays the treatment plan parameters for each of the treatment plans and/or dose delivery maps. The treatment report system 36 also includes a user interface device 48 which enables a clinician to choose desired institutions, patients, clinicians, treatment plans, dose deliver maps, and the like. After selection of the desired institution(s), patient(s), clinician(s), treatment plan(s), dose delivery map(s), and the like the selection module 40 automatically and dynamically creates a selection list of the institution(s), patient(s), treatment plan(s), dose delivery map(s), treatment plan parameters, and the like associated with the desired selection that need to be accessed in an automated manner.

The planning module 42 receives the selection list from the selection module 40 and consists of one or more user-defined selection scripts which enable treatment plan and/or delivered dose data from the particular combination of institution(s), patient(s), treatment plan(s), and dose delivery map(s) to be automatically accessed in a sequential or parallel manner. The planning module 42 displays all information and treatment plan parameters relevant to the particular treatment plan(s) and/or dose delivery map(s) that has been selected or opened (e.g. structures, points of interest, beams, optimization objectives, dose grids, dose volume histograms (DVHs), and the like). For example, the planning module 42 stores the one or more user-defined selection scripts in the treatment database 38 and utilizes an initialization script to execute the one or more user-defined selection scripts. The initialization script executes each user-defined selection script in an individual manner. The user-defined selection script queries the desired treatment plan parameters from the patient's treatment plans and/or delivery dose maps. It is also contemplated that clinicians create specific scripts for extracting data from the selected particular treatment plan(s) and/or dose delivery map(s). For example, the clinician defined scripts enable clinicians to create a set of rules for determining what data be extracted from the selected particular treatment plan(s) and/or dose delivery map(s).

The reporting module 44 receives the treatment plan parameters and stores the information in for instance a dedicated database or in a report file. 38. This data includes (a reference to) the treatment plan parameters and can be subsequently accessed and imported into other programs for further processing as needed. In case the TPS offers the option to choose a specific type of plan and for instance includes (automated) routines to create such a type of plan, clinicians can quickly select a set of plans by their plan type for review. For example, selection of all plans created with a protocol to treat the prostate with five external beams. After the treatment plan characteristics have been queried and written to the report file, the initialization script contains a command to execute the next user selection script and write that patient's treatment plan parameters to the report file. It is also contemplated that the planning module 42 execute multiple user selection scripts in parallel in order to more efficiently access the treatment plans and/or delivery dose maps.

The reporting module 44 also enables a clinician to select which treatment plan parameters to write to the report file. For example, a clinician utilizes the user interface device 48 to select what desired treatment plan parameters should be written to the report. The treatment plan parameters accessed from the different treatment plans and/or delivery dose maps can be processed in various ways, including (but not limited to) cumulatively writing the data to a file, writing the data to multiple files, displaying the data in a browser window or multiple browser windows etc. The output file(s) may be imported into viewing/processing software for post-processing and/or report generation. The high-level programming functionality in the treatment planning system can also be utilized to generate reports in any desired format. For example, the output file(s) are fed to a recommender which analyzes the report file(s) and suggest methods of improving efficiency associated with automated treatment plan review and treatment. The high-level programming functionality in the treatment planning system can also be utilized to generate reports in any desired format. For example, the reports are formatted for specific agency purposes in order to improve the workflow of determining credentialing, future reimbursement rates, and the like. It should also be appreciated that the reporting module 44 allow clinicians to select desired institution(s), patient(s), clinician(s), treatment plan(s), dose delivery map(s), and the like as favorite parameters. For example, the reporting module 44 enables clinicians to view their personal favorite parameters. It is also contemplated the reporting module 44 write a report modules using all or selected favorite parameters.

The planning system 16, the therapy control system 32, and the treatment report system 36 include one or more memories 50 and one or more processors 52. The memories 50 store executable instructions for carrying out the functions associated with the planning system 16 and the therapy control system 32, and the treatment report system 36, including those associated with the segmentation module 18, the mapping module 34, the optimization module 20, the motion module 22, the selection module 40, the planning module 42, and the reporting module 44. The processors 52 execute the executable instructions stored on the memories 50. In certain embodiments, the planning system 16 and/or the therapy control system 62 include communication units 54 for communicating with, for example, each other, the image memories 14, the therapy memories 28, and so on, via a communications network and/or a data bus, such as a local area network or the Internet.

With reference to FIG. 2, a flowchart diagram for automated multi-patient treatment plan access from a current institution 100 including a number of patients 102 is illustrated. The flowchart includes a selection level 102 and a planning level 104. In the selection level 102, the treatment planning system is started 108. The treatment planning system provides a clinician a list of clinician(s), treatment plan(s), dose deliver map(s), and the like for each patient for the clinician to select. After selection of the desired patient(s), clinician(s), treatment plan(s), dose delivery map(s), and the like the treatment planning system creates a selection list of the patient(s), treatment plan(s), dose delivery map(s), treatment plan parameters, and the like associated with the desired selection that need to be accessed in an automated manner. In the planning level 104, the treatment plan parameters for the desired selection are queried 110 from the patient's treatment plans and/or delivery dose maps. The planning level 104 also writes/appends the queried treatment plan parameters to a report file 112. After the report file is written, the treatment planning system is exited 114.

With reference to FIG. 3, a flowchart diagram for automated multi-patient treatment plan access is illustrated. In a step 200, selection level operation is opened. During selection level operation, lists of all institutions, patients, treatment plans, delivery dose maps, and the like are displayed. A clinician selects desired institution(s), patient(s), clinician(s), treatment plan(s), dose delivery map(s), and the like and creates a one or more auto-review scripts corresponding to each patient/plan. In a step 202, the auto-review script is executed. In a step 204, the planning level is accessed for the current patient, institution, plan, and the like. In a step 206, the user-defined review script is executed and the treatment plan parameters are written/appended to a report file. During step 206, the treatment plan parameters for the desired selection are queried from the patient's treatment plans and/or delivery dose maps. In a step 208, it is determined if all of the selected patient/plans are completed. If all of the selected patient/plans are not completed, then system is returned to selection level operation in a step 210. It is also contemplated that returning to the selection level operation is optional. The selected patient/plans can be processed as is or can be collated from additional selections. In a step 212, the next selected patient/plan is selected and the process returns to step 204 with the next selected patient/plan. If it is determined that all of the selected patient/plans are completed, the report is finalized and stored in a step 214.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for reviewing a treatment plan, the method comprising:
displaying list of at least one of a selected plurality of patients, institutions, and treatment plans associated with a treatment planning system;
selecting at least one of the one or more patients, institutions, and treatment plans;
querying treatment plan parameters associated with the selected one or more patients, institutions, and treatment plans; and
generating a report file of the queried treatment plan parameters.

2. The method according to claim 1, further including:
creating a selection list of the institution(s), patient(s), treatment plan(s), dose delivery map(s), treatment plan parameters, and the like associated with the selected one or more patients, institutions, and treatment plans.

3. The method according to claim 1, further including:
creating a selection script for each patient associated with the selection list, the selection script querying treatment plan parameters from the patient's treatment plans and/or delivery dose maps.

4. The method according to claim 1, further including:
processing the selection scripts for each patient associated with the selection list in a sequential manner until all the selection scripts are processed.

5. The method according to 4 claim 1, further including:
processing the selection scripts for each patient associated with the selection list in a parallel manner until all the selection scripts are processed.

6. The method according to claim 1, wherein the step of generating a report file includes at least one of cumulatively writing the data to a file, writing the data to multiple files, and displaying the data in a browser window or multiple browser windows.

7. The method according to claim 1, further including:
selecting desired treatment plan parameters to be included in the report.

8. The method according to claim 1, wherein the selected treatment plan parameters include delivery dose distributions.

9. A non-transitory computer-readable medium carrying software which controls one or more processors to perform the method according to claim 1.

10. A treatment planning system, the system comprising:
a display which displays at least one of all patients, institutions, and treatment plans associated with a treatment planning system;
a planning system which enables a clinician to select at least one of the one or more patients, institutions, and treatment plans; and
a treatment report system queries treatment plan parameters associated with the selected one or more patients, institutions, and treatment plans and generates a report file of the queried treatment plan parameters.

11. The system according to claim 10, wherein the planning system creates a selection list of the institution(s), patient(s), treatment plan(s), dose delivery map(s), treatment plan parameters, and the like associated with the selected one or more patients, institutions, and treatment plans.

12. The system according to claim 10, wherein the treatment report system creates a selection script for each patient associated with the selection list, the selection script querying treatment plan parameters from the patient's treatment plans and/or delivery dose maps and processes the selection scripts for each patient associated with the selection list until all the selection scripts are processed.

13. A treatment planning system, the system comprising:
one or more processors programmed to:
display at least one of all patients, institutions, and treatment plans associated with a treatment planning system;
select at least one of the one or more patients, institutions, and treatment plans;
query treatment plan parameters associated with the selected one or more patients, institutions, and treatment plans; and
generate a report file of the queried treatment plan parameters.

14. The treatment planning system according to claim 13, wherein the one or more processors are further programmed to:
create a selection list of the institution(s), patient(s), treatment plan(s), dose delivery map(s), treatment plan parameters, and the like associated with the selected one or more patients, institutions, and treatment plans.

15. The treatment planning system according to claim 13, wherein the one or more processors are further programmed to:
creating a selection script for each patient associated with the selection list, the selection script querying treatment plan parameters from the patient's treatment plans and/or delivery dose maps.

16. The treatment planning system according to claim 13, wherein the one or more processors are further programmed to:
process the selection scripts for each patient associated with the selection list in a sequential manner until all the selection scripts are processed.

17. The treatment planning system according to claim 13, wherein the one or more processors are further programmed to:
process the selection scripts for each patient associated with the selection list in a parallel manner until all the selection scripts are processed.

18. The treatment planning system according to claim 13, wherein the step of generating a report file includes at least one of cumulatively writing the data to a file, writing the data to multiple files, and displaying the data in a browser window or multiple browser windows.

19. The treatment planning system according claim 13, further including:
a display which displays at least one of all patients, institutions, and treatment plans associated with a treatment planning system and the report file.

20. The treatment planning system according to claim 13, further including:
one or more databases which store the treatment plan parameters and the report file.
